(19) United States
(12) Patent Application Publication
(10) Pub. No.: US 2010/0199460 A1
(43) Pub. Date: Aug. 12, 2010

(54) DEVICE ACTING AS A STAND-OFF BETWEEN AN OPENING ELEMENT AND A FIXED ELEMENT, PARTICULARLY OF A MOTOR VEHICLE

(75) Inventor: Stephane Perche, Saint Bardoux (FR)

Correspondence Address: CANTOR COLBURN, LLP, 20 Church Street, 22nd Floor, Hartford, CT, 06103, US

(73) Assignee: EXSTO, Romans sur Isere (FR)

(21) Appl. No.: 12/677,145

(22) PCT Filed: Sep. 9, 2008
(86) PCT No.: PCT/EP08/61924

§ 371 Date: Mar. 26, 2010

(30) Foreign Application Priority Data
Sep. 12, 2007 (FR) 07/06393

(51) Int. Cl. E05C 17/20

(52) U.S. Cl. 16/82

(57) ABSTRACT

The present invention relates to a device (1) acting as a stand-off holding a door away from a frame, comprising a yoke (2) for attaching to the frame, and a support element (4) for attaching to the door, the support element being extended by a guide (3) comprising a contact zone broken down into a first and a second track (22, 23) running respectively on each side of ramps (21), the yoke being fitted with a follower element (10) designed to travel along the contact zone so that the opening element can be positioned alternately in a closed position or in an open position, characterized in that the guide is designed in such a way that the contact zone is created in a housing that has at least one overlapping wall (17) protecting the said contact zone from any splashes and/or any unwanted deposition of dirt.

### TECHNICAL FIELD

The present invention relates to a device for spacing an opening element away from a fixed element, and more particularly to a device for spacing a door away from the frame of a motor vehicle body.

### BACKGROUND

Installing such a spacing device, in particular between each door and the frame of the motor vehicle, has been known for a very long time.

Generally, this spacing device is made of steel and comprises first means for fastening to the opening element or the fixed element and also second means for fastening to the fixed element or the opening element, the second fastening means being extended by a guide comprising a zone of contact which is made up of a first track and a second track extending on either side of means for resisting movement, the first fastening means being equipped with at least one follower element designed to be moved along the zone of contact in order that the opening element can be located either in an open position or a closed position.

The means for resisting movement consist of a protruding tip of the guide and compel the person opening the opening element to exert additional forces so as to force the follower element to pass over this obstacle in order to come into contact with the second track. The opening element is then stabilized in the open position.

It is therefore necessary to exert forces in the opposite direction in order to force the follower element to pass over the tip so as to come back into contact with the first track so as to close the opening element.

A major drawback of this type of spacing device lies in the fact that, during opening/closing maneuvers following the steps of cataphoresis and/or of application of one or more coats of paint, particles or flakes are formed by the follower element rubbing against the zone of contact which has been at least partially covered with one or more of these coatings during the above-identified steps. These flakes, mainly under the effect of gravity and/or of splashing, then become deposited on a part of the frame located underneath and constitute visual defects once they are covered with a coat of paint for example.

While such defects may be permitted for entry level vehicles, they are not acceptable for top of the range vehicles where the finish must be exemplary.

### BRIEF SUMMARY

The present invention aims to solve the abovementioned problem and for this purpose provides a device for spacing an opening element away from a fixed element, said spacing device comprising first means for fastening to the opening element or the fixed element and also second means for fastening to the fixed element or the opening element, the second fastening means being extended by a guide comprising a zone of contact which is made up of a first track and a second track extending on either side of means for resisting movement, the first fastening means being equipped with at least one follower element designed to be moved along the zone of contact in order that the opening element can be located either in a closed position or an open position depending on whether the follower element is in contact with the first track or with the second track, characterized in that the guide is designed such that the zone of contact is formed in a housing having at least one covering wall protecting said zone of contact from any splashing and/or from any deposition of unwanted dirt.

Thus, since the zone of contact is protected from the outside, in particular during steps of cataphoresis and/or of application of one or more coats of paint, rubbing of the follower element against the zone of contact no longer generates contaminating flakes or dust liable to be deposited by gravity and/or splashing on the bottom part of the frame.

Advantageously, the housing comprises two side walls located on either side of the covering wall.

Further advantageously, each side wall has an inner face and the contact surface is formed in said inner faces.

According to a preferred embodiment, the guide has an approximately inverted-U-shaped cross section once positioned in the opening element or in the corresponding fixed element.

Preferably, the first fastening means comprise a bracket.

Further preferably, the follower element comprises an approximately cylindrical sliding finger.

According to one characteristic of the invention, the means for resisting movement comprise at least one narrowing formed in the zone of contact.

Preferably, the narrowing is made with the aid of at least two elastically deformable elements located opposite one another.

Further preferably, each elastically deformable element comprises an internal shoulder forming a ramp in the direction of the second track.

According to a first variant embodiment of the invention, the spacing device is made of plastic. Thus, such a spacing device can be installed temporarily with a view to applying various coatings on the opening element and/or on the entire body and is then replaced by a conventional metal spacing device as is described for example in the introductory part of the present application.

According to a second variant embodiment of the invention, the spacing device is made of metal. The fastening means and the guide can be made in the form of a one-piece body. Such a spacing device could then be installed permanently.

The present invention also relates to a guide for such a spacing device, said guide comprising a zone of contact which is made up of a first track and a second track extending on either side of means for resisting movement, characterized in that the means for resisting movement comprise at least one narrowing formed in the zone of contact.

### BRIEF DESCRIPTION OF THE DRAWINGS

The implementation of the invention will be understood better with the aid of the following detailed description with regard to the appended drawing, in which:

FIG. 1 is a perspective top view of the spacing device according to the invention in the closed position;

FIG. 2 is a perspective bottom view of the spacing device shown in FIG. 1;

FIG. 3 is a view similar to FIG. 2, when the spacing device is in the open position;

FIG. 4 is a detail view of the spacing device shown in FIG. 3 at the means for resisting movement;

FIG. 5 is a view of the spacing device according to the invention in the open position once it has been mounted on a vehicle; and

FIG. 6 is a view from inside the vehicle of the spacing device in the closed position.

### DETAILED DESCRIPTION

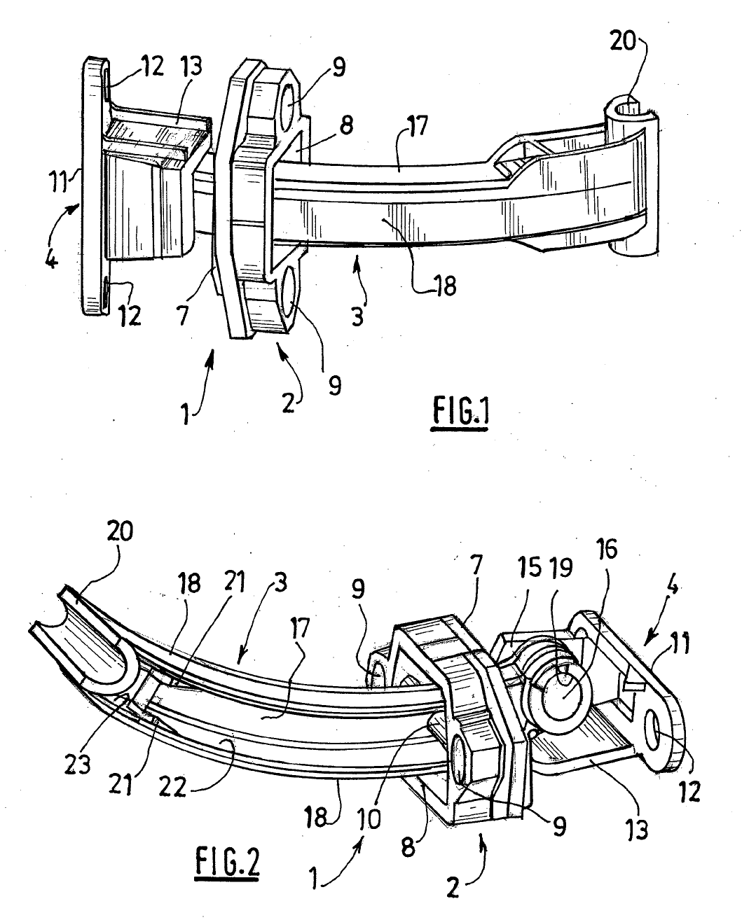

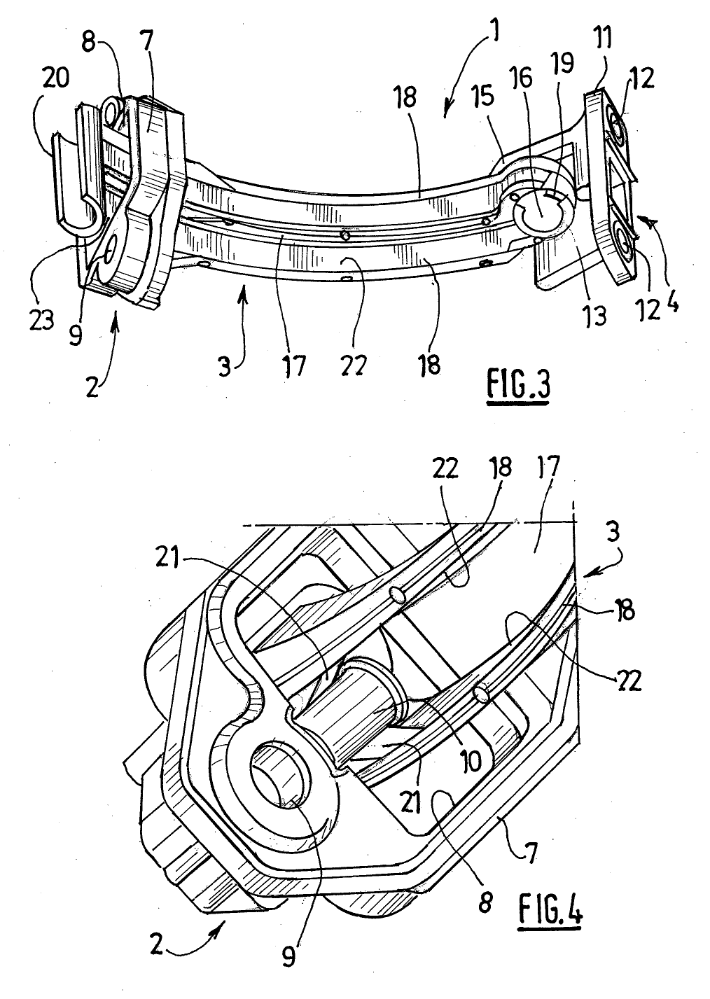

A spacing device 1 according to the invention, as shown in FIGS. 1 to 4, is made up of three separate parts, preferably made of plastic, namely a bracket 2, a guide 3 passing through the bracket 2, and a support element 4 to which the guide 3 is attached. However, it must be understood that a variant embodiment could provide the support element 4 and the guide 3 in one piece.

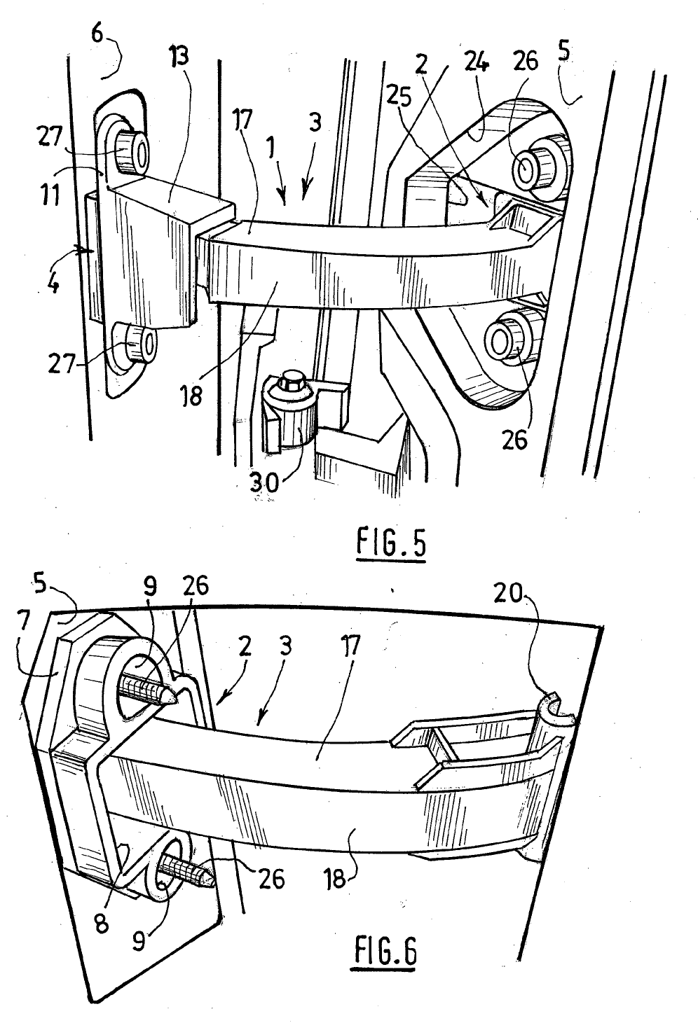

More precisely, and as is shown in FIGS. 5 and 6, the bracket 2 and the support element 4 constitute respectively the first means for fastening the spacing device 1 to a fixed element, in this case a frame 6 of a motor vehicle, and the second means for fastening the spacing device 1 to an opening element, in this case a door 5. The door 5 is hinged to the frame 6 by way of a plurality of hinges 30.

The bracket 2 is made in one piece and comprises a substantially rectangular rim 7 delimiting a central opening 8. On either side of the latter, each long side is extended symmetrically by a fastening zone comprising a central bore 9.

A follower element, made in the form of an approximately cylindrical sliding finger 10 located in the plane of the bracket 2, protrudes from one of the long sides and leads into the central opening 8. This sliding finger 10 is formed so as to extend in parallel with a finger connecting the centers of the two bores 9.

The support element 4 comprises an elongate plate 11 which has an orifice 12 at each of its two ends and from which an L-shaped partition 13 protrudes. This partition 13 comprises a base 15 surmounted by a stud 16.

The guide 3 is made in the form of a slightly bent elongate piece and has a U-shaped cross section. For this purpose, this guide 3 comprises a covering wall 17 and also two side walls 18 located on either side of said covering wall 17 and perpendicular thereto. The width of the covering wall 17 is selected such that the shortest distance between the internal faces of the two side walls 18 is approximately equal to the diameter of the sliding finger 10.

This guide 3 has a first end terminating in a bore 19 designed to engage with the stud 16 by mating of shapes. The guide 3 could for this purpose pivot to a certain extent about the stud 16 so as to make the spacing device 1 adaptable and thus usable on different types of vehicle. This guide 3 also has a second end including a semicylindrical partition 20 forming an abutment.

Close to the second end of the guide 3, each internal face of the side walls 18 comprises an internal shoulder forming a ramp 21.

These two ramps 21 are opposite one another and act as means for resisting movement which are made in the form of a narrowing. More precisely, the internal faces constitute a zone of contact with the sliding finger 10, this zone of contact being made up of a first track 22 running from the first end of the guide 3 to said ramps 21, and also of a second track 23 running schematically from said ramps 21 as far as the vicinity of the partition 20.

The ramps 21 are designed so as to have an upward slope in the direction of the second track 23.

As shown in FIGS. 5 and 6, the spacing device 1 is mounted on the vehicle as follows.

The second end of the guide 3 has already been slid through the central opening 8 in the bracket 2. The sliding finger 10 is then in contact with the internal walls of the side walls 18, preferably in the first track 22.

As can be gathered more particularly from FIG. 6, the bracket 2 is first of all fastened in an upright of the frame 6 with the aid of two fastening screws 26 inserted in the bores 9 of the bracket 2 and into two corresponding bores formed in said upright. The latter has two opposite openings 24, 25 in order for the first end of the guide 3 to pass through.

It should be understood that the bracket 2 has been fastened such that the covering wall 17 of the guide 3 is located above the sliding finger 10. The covering wall 17 and the side walls 18 then constitute a housing in the form of a tunnel in which the sliding finger 10 and the internal faces of the side walls 18 are protected from any kind of splashing and/or unwanted dirt which could occur, for example, during the steps of applying one or more coats of paint. Therefore, the rubbing of the sliding finger 10 against the zone of contact of the guide 3 does not produce any flakes or dust liable to be deposited, under the effect of gravity and/or of splashing, on the parts of the frame located underneath.

The bore 19 in the guide 3 is then fitted over the stud 16 and the support element 4 is fastened in the door 5 via its plate 11, as shown in FIG. 5. For this purpose, two fastening screws 27 are inserted into the two orifices 12 and into two corresponding orifices formed in said door 5.

In both directions, the ramps 21 constitute a resistance point which, in order to be passed over, requires an increase in the forces exerted on the door 5. By doing this, the sliding finger 10 can pass through the narrowing by causing elastic deformation of the ramps 21 so as to widen the passage.

When the door 5 is placed in the open position, the sliding finger 10 is stabilized between the ramps 21 and the partition 20, the bracket 2 then being in contact with said partition 20.

It should be noted that the support element and the guide could alternatively be made in one piece. This would remove the degree of latitude in the possible rotation of the bore 19 about the stud 16.

Although the invention has been described in connection with particular exemplary embodiments, it is clear that it is in no way limited thereto and that it includes any technical equivalents of the means described as well as their combinations, as long as these fall within the scope of the invention.

1. A device for spacing an opening element away from a fixed element, said device comprising:
first means for fastening to the opening element or the fixed element and;
second means for fastening to the fixed element or the opening element, the second fastening means being extended by a guide comprising a zone of contact comprising a first track and a second track extending on either side of means for resisting movement;
wherein the first fastening means is equipped with at least one follower element designed to be moved along the zone of contact in order that the opening element can be located either in a closed position or an open position depending on whether the follower element is in contact with the first track or with the second track; and
wherein the guide is designed such that the zone of contact is formed in a housing having at least one covering wall protecting said zone of contact from any splashing and/or from any deposition of unwanted dirt.

2. The spacing device as claimed in claim 1, wherein the housing comprises two side walls located on either side of the covering wall.

3. The spacing device as claimed in claim 2, wherein each side wall has an inner face and in that the contact surface is formed in said inner faces.

4. The spacing device as claimed in claim 1, wherein the guide has an approximately inverted-U-shaped cross section once positioned in the opening element or in the corresponding fixed element.

5. The spacing device as claimed in claim 1, wherein the first fastening means comprise a bracket.

6. The spacing device as claimed in claim 1, wherein the follower element comprises an approximately cylindrical sliding finger.

7. The spacing device as claimed in claim 1, wherein the means for resisting movement comprise at least one narrowing formed in the zone of contact.

8. The spacing device as claimed in claim 7, wherein the narrowing is delimited by at least two elastically deformable elements located opposite one another.

9. The spacing device as claimed in claim 8, wherein each elastically deformable element comprises an internal shoulder forming a ramp in a direction of the second track.

10. A guide for a spacing device as claimed in claim 1, said guide comprising a zone of contact which is made up of a first track and a second track extending on either side of means for resisting movement, wherein the means for resisting movement comprise at least one narrowing formed in the zone of contact.
